(19) United States
(12) Patent Application Publication
(10) Pub. No.: US 2025/0200632 A1
(43) Pub. Date: Jun. 19, 2025

(54) SUGGESTING REPLACEMENT ITEMS BY INFERRING INTENT OF A USER OF AN ONLINE SYSTEM USING A TRAINED MODEL

(71) Applicant: Maplebear Inc., San Francisco, CA (US)

(72) Inventors: Charles Wesley, San Diego, CA (US); Brent Scheibelhut, Toronto (CA)

(21) Appl. No.: 18/542,239

(22) Filed: Dec. 15, 2023

(51) Int. Cl. G06Q 30/0601

(52) U.S. Cl. CPC G06Q 30/0631; G06Q 30/0635

(57) ABSTRACT

A recipe prediction model is used to suggest replacement items by inferring intent of a user of an online system. Upon receiving a signal indicating that an item in a cart requested by the user is not available and responsive to identifying a failure of a replacement model to identify suitable replacement items according to defined criteria, the online system applies the recipe prediction model trained to infer a recipe that is potentially associated with the item and output a recipe's name and a replacement item category. The online system collects, based on the recipe's name, a set of recipes from a database. The online system identifies, from the set of recipes, based on the replacement item category, a set of candidate replacement items. A device associated with the user displays a user interface with one or more replacement items selected for recommendation to the user.

### BACKGROUND

In present-day online systems, such as online concierge systems, items selected by users often face availability issues at the time of delivery, necessitating item replacements. The online concierge system typically utilizes the replacement machine-learning model to predict whether a user will accept a replacement item that is recommended to the user based on the user's purchase history, similarity with the originally requested item, etc. Hence, existing solutions suggest replacements based only on the individual item's characteristics and past user data, but they neglect the context of user's intent in a specific order. This may result in less optimal item replacement suggestions especially when an entire product category is low in stock. Hence, it is often desirable to provide replacement suggestions on a large scale when certain products or an entire product category requested by a user of an online concierge system is out-of-stock.

An online concierge system typically provides item replacement suggestions when an originally ordered item is not available. Traditionally, the online concierge system uses a machine-learning model that predicts whether a user would accept a candidate replacement suggestion. However, the traditional replacement machine-learning models have certain shortcomings. For example, predictions identified by the traditional machine-learning models may have a low confidence. Additionally, other appropriate replacements recommended by the traditional machine-learning models sometimes are themselves not available. Hence, there is a technical problem that sometimes the traditional machine-learning models cannot provide appropriate replacement suggestions for missing items. Therefore, there is a need for a new type of machine-learning model approach when recommending replacement suggestions for missing items.

### SUMMARY

Embodiments of the present disclosure are directed to utilizing a trained computer model to determine one or more replacement items for recommendation to a user of an online system (e.g., online concierge system) by inferring intent of the user for an order that is being fulfilled at the online system.

In accordance with one or more aspects of the disclosure, the online system receives a signal indicating that an item in a cart requested by the user is not available. The online system accesses a replacement computer model trained to identify a set of one or more replacement items for replacing the item. The online system applies the replacement computer model to score, based at least in part on one or more features of the item, each replacement item in the identified set of one or more replacement items. Responsive to identifying a failure of the replacement computer model to identify one or more suitable replacement items according to defined criteria, the online system accesses a recipe prediction computer model trained to infer a recipe that is potentially associated with the item. The online system applies the recipe prediction computer model to output, based at least in part on the one or more features of the item and information about one or more ingredients in the cart, a name of the inferred recipe and a replacement item category from content of the inferred recipe. The online system collects, from a database of recipes of the online system and based on the name of the inferred recipe, a set of one or more recipes. The online system identifies, from the set of one or more recipes, based on the replacement item category, a set of one or more candidate replacement items. The online system causes a device associated with the user to display a user interface with one or more replacement items selected from the set of one or more candidate replacement items for recommendation to the user to be included in the cart instead of the item.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3A illustrates an example user interface with a suggested replacement item displayed at a user client device, in accordance with one or more embodiments.

FIG. 3B illustrates an example user interface with a suggested replacement item and an inquiry message for a user of an online concierge system displayed at a user client device, in accordance with one or more embodiments.

FIG. 4 is a flowchart for a method of using computer models to determine one or more replacement items for recommendation to a user of an online concierge system by inferring intent of the user when placing an order at the online concierge system, in accordance with one or more embodiments.

### DETAILED DESCRIPTION

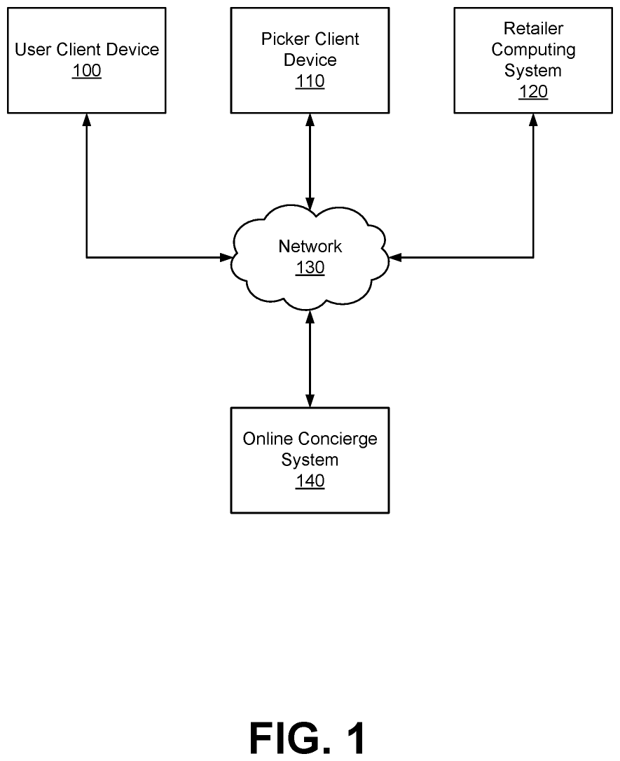

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 fulfills an order placed by a user of the online concierge system 140 by dispatching a picker to a retailer location to obtain items from an order placed by the user and deliver the order to the user. When an item from the order is unavailable at the retailer location, the online concierge system 140 deploys a trained replacement computer model (e.g., machine-learning computer model) to identify one or more suitable replacement items. However, the replacement computer model is not trained to infer a user's intent in relation to the current order based on the context and content of the user's current shopping cart. Instead, the replacement computer model looks at individual items, user's purchase history, and user's preferences, but not at the totality of cart items to infer the user's intent.

To infer the user's current intent in relation to the order and thereby improve the replacement model, the online concierge system 140 presented herein trains and applies a new contextual replacement computer model to operate as a recipe prediction computer model (e.g., machine-learning computer model) that infers a recipe that an item to be replaced is being used for. Inputs to the recipe prediction computer model are content of the current user's shopping cart and a database of recipes that is available at the online concierge system 140. The database of recipes may be pre-stored at the one or more computer-readable media of the online concierge system 140. Alternatively or additionally, a database of recipes can be dynamically built at the online concierge system 140 based on, e.g., ingredient data collected when users view certain online recipes and then add corresponding items to their carts.

Information about the inferred recipe as output by the recipe prediction computer model is provided to the replacement computer model to improve its prediction of one or more suitable replacement items for recommendation to the user. The recipe prediction computer model may also prompt the user to confirm or deny the inferred intent. The use of the recipe prediction computer model may be triggered when an availability computer model of the online concierge system 140 has low confidence that the original recommendations from the replacement model will be available. Alternatively, the use of the recipe prediction computer model may be triggered when the replacement computer model (or availability computer model) has low confidence for availability of an entire category of items.

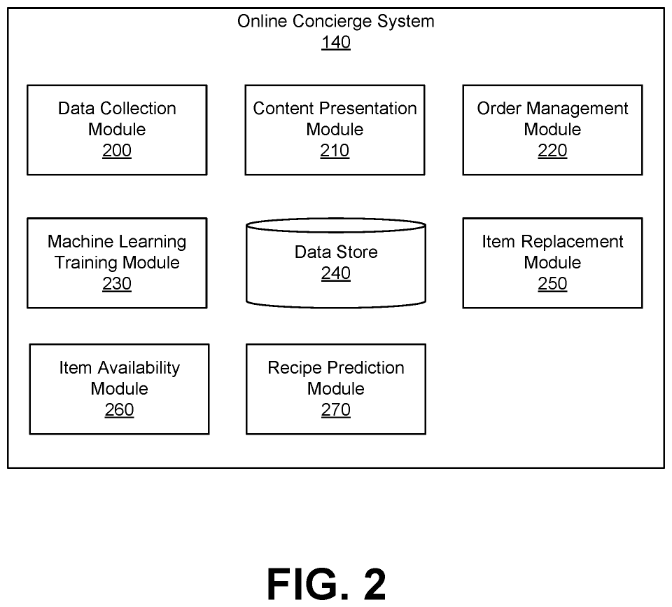

Hence, the online concierge system 140 presented herein runs a more holistic, customer-centric method for suggesting item replacements in online settings. The method presented herein leverages the trained recipe prediction computer model to infer a customer's potential intent or planned recipe based on the composition of their current shopping cart. By utilizing the recipe prediction computer model, the online concierge system 140 provides more context-aware replacement recommendations, especially in situations where an entire product category is expected to be low or out-of-stock. The online concierge system 140 is described in further detail below with regards to FIG. 2.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, an item replacement module 250, an item availability module 260, and a recipe prediction module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The item replacement module 250 may receive a message from a picker (e.g., from the picker client device 110) that an item originally selected by a user of the online concierge system 140 is not available at a retailer location. Upon receiving the message, the item replacement module 250 may apply a replacement computer model (e.g., machine-learning computer model) trained to identify a set of one or more replacement items for recommendation to the user and a replacement score for each item in the identified set of one or more replacement items. In addition to identifying the replacement scores, the replacement computer model may also identify a confidence score for availability of each replacement item at the retailer location. Alternatively, as described below, a different computer model (e.g., availability computer model) may be applied to identify the confidence score for availability of each replacement item. When the confidence score for availability of each replacement item is below a first threshold score (i.e., when individual items are likely out-of-stock) or the confidence score for availability of the entire category of items is below a second threshold score (i.e., when the whole category of items in the item taxonomy is likely out-of-stock), the online concierge system 140 triggers operations of the recipe prediction module 270 to infer a recipe (or composite item) that is potentially related to the originally selected unavailable item.

The replacement computer model deployed by the item replacement module 250 may run a machine-learning algorithm to identify, based on one or more features of the originally selected item, the set of one or more replacement items and to score each item in the identified set of one or more replacement items. A set of parameters for the replacement computer model may be stored at one or more non-transitory computer-readable media of the item replacement module 250. Alternatively, the set of parameters for the replacement computer model may be stored at one or more non-transitory computer-readable media of the data store 240.

The item availability module 260 may determine a confidence score for availability at the retailer location of each replacement item in the identified set of one or more replacement items determined by the replacement computer model. The item availability module 260 may apply an availability computer model (e.g., machine-learning computer model) trained to generate an availability score for each item in the identified set of one or more replacement items. The availability score generated by the availability computer model may be a metric that represents a likelihood of availability at the retailer location for each item in the set of one or more replacement items as identified by the replacement computer model. The availability computer model deployed by the item availability module 260 may run a machine-learning algorithm to generate, based on information from a retailer in relation to the identified set of one or more replacement items, the availability score for each item in the identified set of one or more replacement items. A set of parameters for the availability computer model may be stored at one or more non-transitory computer-readable media of the item availability module 260. Alternatively, the set of parameters for the availability computer model may be stored at one or more non-transitory computer-readable media of the data store 240.

In one or more embodiments, the availability computer model deployed by the item availability module 260 generates an availability score for each replacement item as identified by the replacement computer model. Alternatively or additionally, the availability computer model may generate an availability score for the entire category of items associated with a set of replacement items identified by the replacement computer model. When the availability score for each replacement item is below a first threshold score (i.e., when individual items are likely out-of-stock) or the availability score for the entire category of items is below a second threshold score (i.e., when the whole category of items in the item taxonomy is likely out-of-stock), the online concierge system 140 triggers operations of the recipe prediction module 270 to infer a recipe (or composite item) that is potentially related to the originally selected unavailable item.

Hence, the context-related replacement method presented herein may be initiated when the entire category of items is likely unavailable. In such cases, the online concierge system 140 may be prompted to analyze possible replacements that are outside of the traditional generic replacements by inferring the context for which the user is likely purchasing the unavailable item. The online concierge system 140 is then able to find other context-aware suitable replacements. For example, if the sour cream requested by the user is not available and the user is likely making brownies (e.g., as inferred by the recipe prediction module 270), then the online concierge system 140 may suggest Greek yogurt as a replacement. In contrast, if the recipe prediction module 270 infers that the user is making tacos, the online concierge system 140 may not suggest Greek yogurt as a replacement.

The recipe prediction module 270 may apply a recipe prediction computer model (e.g., machine-learning computer model) trained to infer, from a database of recipes (e.g., as available at the data store 240), a recipe that is potentially associated with the unavailable item. The recipe prediction computer model deployed by the recipe prediction module 270 may run a machine-learning algorithm to output, based at least in part on one or more features of the unavailable item and information about one or more ingredients in the user's cart, at least a name of the inferred recipe and a replacement item category. A set of parameters for the recipe prediction computer model may be stored at one or more non-transitory computer-readable media of the recipe prediction module 270. Alternatively, the set of parameters for the recipe prediction computer model may be stored at one or more non-transitory computer-readable media of the data store 240. In one or more embodiments, the recipe prediction computer model is a large (e.g., bucketed) neural network based multi-task classifier. In one or more other embodiments, the recipe prediction computer model is a language model (e.g., large language model). In one or more other embodiments, the recipe prediction computer model is a two-tower model that initially determines an embedding for the unavailable item and then performs, e.g., the nearest neighbor search for recipes that could be associated with the embedding for the unavailable item.

The recipe prediction module 270 may provide inputs to the recipe prediction computer model, such as, a database of recipe data (e.g., as available at the data store 240), one or more features of the unavailable item, context information including items and ingredients from the current user's cart, information about user's purchase history (e.g., as available at the data store 240), information about user's preferences (e.g., as available at the data store 240), etc. The recipe prediction computer model deployed by the recipe prediction module 270 may output, for a particular unavailable item from the user's cart, information about a recipe that the unavailable item is intended to be used for. In general, for each unavailable item from the user's cart, the recipe prediction computer model may output a predicted recipe name or grouping of recipes for a specific recipe item (e.g., ten recipes for brownies), a suggested replacement item category, and a confidence score for the replacement item category. One example output of the recipe prediction computer model for each unavailable item from the user's cart is: {‘item’: ‘sour cream’; ‘recipe_name’: ‘brownies’; ‘suggested_replacement’: ‘Greek yogurt’; ‘confidence_score’: 0.85}, where ‘sour cream’ is the original unavailable item in the user's cart, ‘brownies’ is the name of “family” of similar recipes the recipe prediction computer model infers that the unavailable item matches, and ‘Greek yogurt’ is the searchable name of appropriate replacement.

Hence, the recipe prediction module 270 deploys the recipe prediction computer model to identify the user's shopping intent. The recipe prediction computer model is trained to analyze the items in the user's cart and cross-reference these items against a comprehensive data set of recipes (e.g., as available at the data store 240). The recipe prediction computer model identifies whether the content of the user's cart indicate attempts to assemble a specific recipe or composite item. For example, if the user has items in the cart such as sour cream, eggs, powdered sugar, cocoa powder, and vanilla extract, the recipe prediction computer model may predict that the user's intent is to make brownies. On the other hand, if the user has sour cream, tortilla chips, shredded Mexican cheese, and salsa in the cart, the recipe prediction computer model may instead predict that the user's intent is to make nachos.

To obtain possible replacements for a single item in the recipe that is missing, two different sources may be utilized. First, it should be ensured that the original recipe data has possible substitutions. Second, the recipe prediction computer model deployed by the recipe prediction module 270 should be trained to identify multiple recipes as being about the same user's intent (e.g., multiple recipes for brownies) and compare the ingredient lists in the multiple recipes to generate a list of ingredients that are likely substitutes for the missing item.

The outputs generated by the recipe prediction computer model—i.e., predicted recipe name or grouping of recipes for a specific recipe item, suggested replacement item category, and confidence score for the replacement item category may be provided to the replacement computer model. The item replacement module 250 may deploy the replacement computer model to identify, based on the one or more features of the unavailable item, the user's order history, user's preferences, the name of the recipe (or the name of group of recipes), the replacement item category and the confidence score, a set of context-aware replacement items for recommendation to the user. Thus, in addition to the one or more features of the unavailable item, the user's order history and the user's preferences that were previously also input to the replacement computer model, additional inputs are provided to the replacement computer model, such as, the name of the recipe (or the name of group of recipes), the replacement item category and the confidence score as output by the recipe prediction computer model. In one or more embodiments, the recipe prediction module 270 collects, from the database of recipes, based on the name of the inferred recipe, a set of one or more recipes. The recipe prediction module 270 may identify, from the set of one or more recipes, based on the replacement item category, the set of context-aware candidate replacement items.

Upon identifying the set of context-aware replacement items, the item availability module 260 may deploy the availability computer model to determine, based on information from the retailer in relation to the set of context-aware replacement items, an availability score for each item in the identified set of context-aware replacement items. Based on the availability score for each item in the identified set of context-aware replacement items, the item availability module 260 may select a list of context-aware replacement items (i.e., one or more context-aware replacement items) from the set of context-aware replacement items for recommendation to the user (e.g., via the user client device 100). In addition to the list of suggested context-aware replacement items, a recipe name may be also output and provided to the user for viewing and verification of the predicted user's intent.

Hence, the replacement computer model, the availability computer model and the recipe prediction computer models working in concert may generate a list of context-aware replacement items for each missing item in the user's cart. Based on the inferred intent, the online concierge system 140 suggests appropriate replacement items for one or more low-stock items in the current order. These suggestions not only consider potential substitutions for individual out-of-stock items, but also take into account other items in the user's cart that align with the inferred recipe or composite item. For example, if the recipe prediction computer model determines the user's intent is to make brownies but the required sour cream is missing, the online concierge system 140 suggests full-fat Greek yogurt as a substitute. This substitute would be, e.g., guacamole or queso if the recipe prediction computer model determines the user's intent is to make nachos. In this manner, the online concierge system 140 offers more accurate and relevant replacements even when entire product categories face low availability.

The content presentation module 210 may obtain the list of suggested context-aware replacement items (e.g., from the item availability module 260 or the item replacement module 250) and cause the user client device 100 to display a user interface with the list of suggested context-aware replacement items. Additionally, the content presentation module 210 may cause the user client device 100 to display the user interface further with information about what the online concierge system 140 predicts the original unavailable item is being used for (e.g., purpose, recipe, composite item, etc.). The user may then confirm or deny the inferred user's intent. This may help providing context to the user for a replacement recommendation that might otherwise seem very wrong. Also, information about the user's response about the inferred intent may be used as labels for updating the set of parameters of the recipe prediction computer model (e.g., via the machine-learning training module 230).

In the event of an anticipated low-stock situation that affects the entire product category, the content presentation module 210 may deliver specific dynamic prompts to the user after checkout, such as, “Making brownies? Want to replace sour cream with Greek yogurt?” The dynamic prompts that are based on the users' inferred intents allow users to express their preferences: whether they accept the suggested replacement, want to choose a different item in the same category, or prefer an item from a different category altogether. Hence, when a recipe name is provided at the output of the recipe prediction computer model, the content presentation module 210 may cause the user client device 100 to display the user interface with additional information to the user alongside the suggested replacement, such as an inquiry message, “Making brownies? Try Greek yogurt instead of sour cream.” The recipe prediction computer model (and optionally the replacement computer model) may be retrained (e.g., via the machine-learning training module 230) based on the user's feedback on whether the inferred recipe correctly predicted a useful replacement for the user.

The machine-learning training module 230 may perform initial training of the recipe prediction computer model. The machine-learning training module 230 (or some other module of the online concierge system 140) may collect initial training data by mapping a set of recipes from the database of recipes (e.g., as available at the data store 240) to a set of items that were included over a defined time period into shopping carts of a group of users of the online concierge system 140 upon the group of users interacted with the set of recipes and then included the set of items into the shopping carts. The machine-learning training module 230 may then use the collected initial training data to train the recipe prediction computer model.

The machine-learning training module 230 may utilize user's feedback in response to the dynamic prompts provided to users to refine the predictive accuracy of the recipe prediction computer model (and, optionally, of the replacement computer model) over time. This feedback-driven iterative refinement increases the ability of the recipe prediction computer model (and, optionally, of the replacement computer model) to accurately predict the user's intent and provide suitable replacements.

In general, the machine-learning training module 230 retrains the set of parameters of the recipe prediction computer model and/or the set of parameters of the replacement computer model by using user feedback on whether the predicted recipe successfully predicted a user's intent. The machine-learning training module 230 may consider the predicted recipe a success in the following three scenarios. First, if the user approves the specific replacement in a different category, indicating that the recipe prediction computer model correctly predicted their intent. Second, if the user selects a different replacement within the same product category, indicating that the recipe prediction computer model still correctly predicted the recipe even if a different item is chosen. Third, if the user selects a different replacement within a similar recipe within the database of recipes. For example, there are three recipes for brownies in the database of recipes, and the first recipe uses butter, the second recipe uses margarine, and the third recipe uses a vegan fat substitute. The recipe prediction computer model may only offer one replacement suggestion (e.g., margarine), but the user selected the vegan fat substitute, the machine-learning training module 230 may consider this as a successful inferring of the user's intent. On the other hand, the machine-learning training module 230 may consider the predicted recipe a failure if the user selects a replacement from a different product category entirely, indicating that the recipe prediction computer model did not accurately predict the recipe. This information about the success and failure may be collected by the machine-learning training module 230 and utilized for updating the set of parameters of the recipe prediction computer model (and, optionally, of the set of parameters of the replacement computer model).

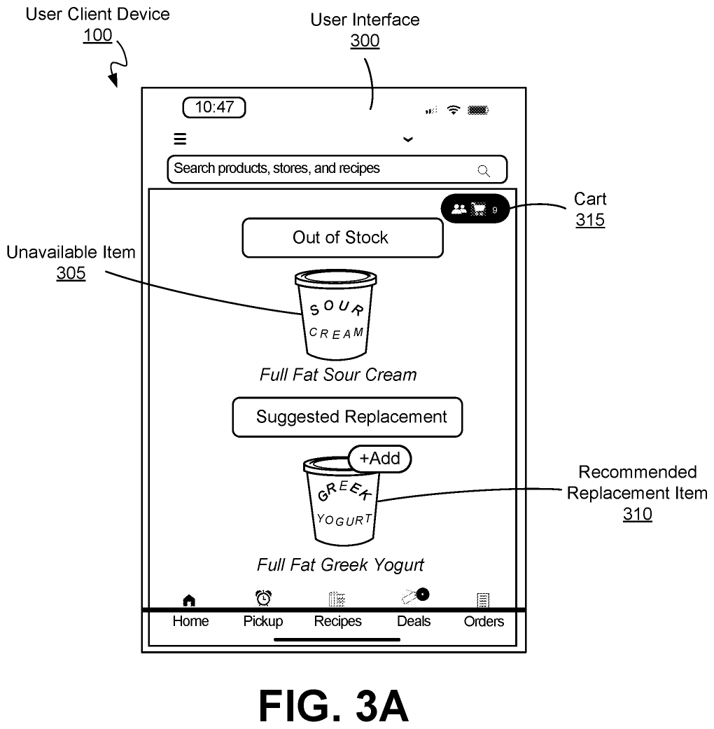

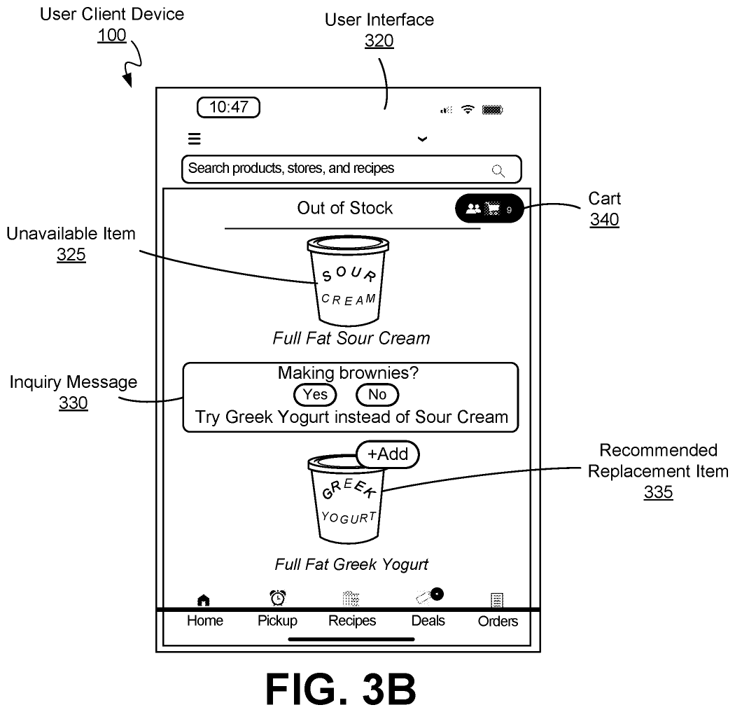

FIG. 3A illustrates an example user interface 300 with a suggested replacement item displayed at the user client device 100, in accordance with one or more embodiments. The user interface 300 may be displayed during an order fulfillment process upon a picker associated with the online concierge system 140 sends a signal message (e.g., via the picker client device 110) that an item 305 originally requested by a user of the online concierge system 140 and included into a cart 315 of the user is not available at a retailer location. For example, the user interface 300 may be displayed after the checkout. Upon triggering the recipe prediction computer model and determining a replacement item for recommendation to the user based on the inferred user's intent in relation to the cart 315, the content presentation module 210 may cause the user client device 100 to display the user interface 300 with a recommended replacement item 310. Alternatively, more than one recommended replacement item may be displayed at the user interface 300. As shown in FIG. 3A, the unavailable item 305 is, e.g., “Sour Cream” and the recommended replacement item 310 is, e.g., “Full Fat Greek Yogurt” because the recipe prediction computer model infers that the user's current intent is to, e.g., make brownies. The user may then utilize the user interface 300 to add the recommended replacement item 310 into the cart 315 instead of the unavailable item 305.

FIG. 3B illustrates an example user interface 320 with a suggested replacement item and an inquiry message for a user of the online concierge system 140 displayed at the user client device 100, in accordance with one or more embodiments. The user interface 320 may be displayed during an order fulfillment process upon a picker associated with the online concierge system 140 sends a signal message (e.g., via the picker client device 110) that an item 325 originally requested by a user of the online concierge system 140 and included into a cart 340 of the user is not available at a retailer location. For example, the user interface 320 may be displayed after the checkout. Upon triggering the recipe prediction computer model and determining a replacement item for recommendation to the user based on the inferred user's intent in relation to the cart 340, the content presentation module 210 may cause the user client device 100 to display the user interface 320 with a recommended replacement item 335. Alternatively, more than one recommended replacement item may be displayed at the user interface 320. As shown in FIG. 3B, the unavailable item 325 is, e.g., “Sour Cream” and the recommended replacement item 335 is, e.g., “Full Fat Greek Yogurt” because the recipe prediction computer model infers that the user's current intent is to, e.g., make brownies.

In addition to the recommended replacement item 335, the content presentation module 210 may cause the user client device 100 to display the user interface 320 further with an inquiry message 330 prompting the user to confirm or deny accuracy of the inferred recipe (i.e., inferred user's intent). As shown in FIG. 3B, the inquiry message 330 may include a text, e.g., “Making brownies? Try Greek Yogurt instead of Sour Cream”, as well as “Yes” or “No” buttons that the user can press to confirm or deny the accuracy of the inferred recipe. A feedback response by the user can be used (e.g., by the machine-learning training module 230) for updating the set of parameters of the replacement computer model and/or the set of parameters of the recipe prediction computer model. The user may have an option to skip answering the inquiry message and proceed with adding the recommended replacement item 335 to the cart 340 instead of the unavailable item 325 if the recommended replacement item 335 is suitable for the user.

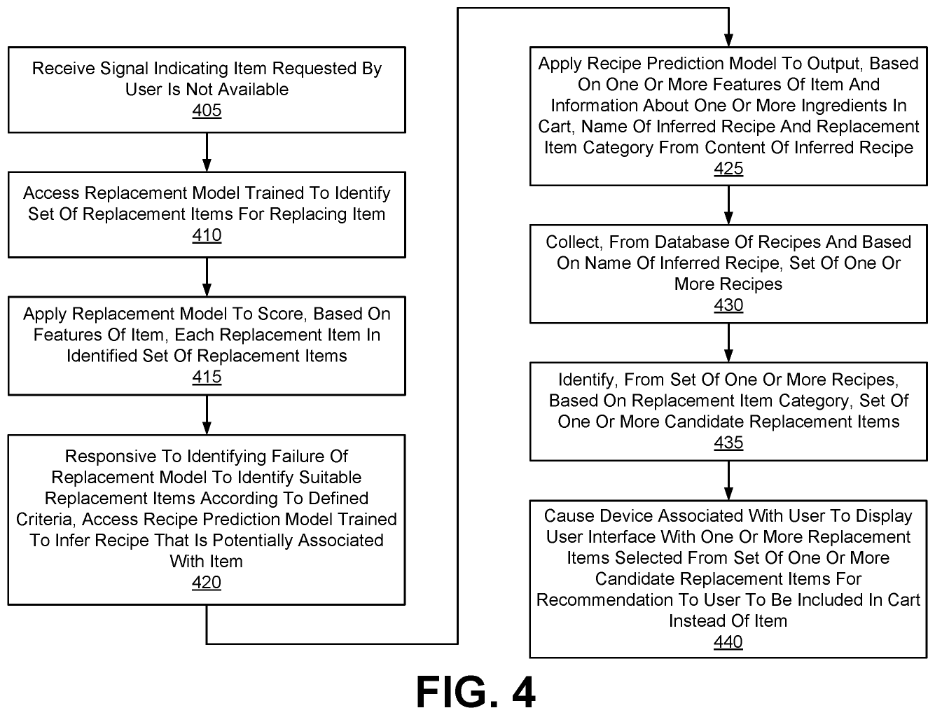

FIG. 4 is a flowchart for a method of using computer models to determine one or more replacement items for recommendation to a user of an online concierge system by inferring intent of the user when placing an order at the online concierge system, in accordance with one or more embodiments. Alternative embodiments may include more, fewer, or different steps from those illustrated in FIG. 4, and the steps may be performed in a different order from that illustrated in FIG. 4. These steps may be performed by an online concierge system (e.g., the online concierge system 140). Additionally, each of these steps may be performed automatically by the online concierge system without human intervention.

The online concierge system 140 receives 405 (e.g., at the item replacement module 250) a signal indicating that an item in a cart requested by a user of the online concierge system 140 is not available. The online concierge system 140 may receive, from a device of a picker associated with the online concierge system 140 (e.g., from the picker client device 110), during fulfillment of an order, the signal indicating that the item in the cart is not available at a store of a retailer.

The online concierge system 140 accesses 410 a replacement computer model of the online concierge system 140 (e.g., via the item replacement module 250) trained to identify a set of one or more replacement items for replacing the item. The online concierge system 140 applies 415 the replacement computer model (e.g., via the item replacement module 250) to score, based at least in part on one or more features of the item, each replacement item in the identified set of one or more replacement items.

Responsive to identifying a failure of the replacement computer model to identify one or more suitable replacement items according to defined criteria, the online concierge system 140 accesses 420 a recipe prediction computer model of the online concierge system 140 (e.g., via the recipe prediction module 270) trained to infer a recipe that is potentially associated with the item. The online concierge system 140 applies 425 the recipe prediction computer model (e.g., via the recipe prediction module 270) to output, based at least in part on the one or more features of the item and information about one or more ingredients in the cart, a name of the inferred recipe and a replacement item category from content of the inferred recipe.

The online concierge system 140 may apply the replacement computer model (e.g., via the item prediction module 250) to generate, based at least in part on the one or more features of the item, a confidence score for availability of each replacement item in the identified set of one or more replacement items. The online concierge system 140 may identify the failure of the replacement computer model by identifying (e.g., via the item prediction module 250) that the confidence score for availability of each item in the identified set of one or more replacement items is below a threshold score.

The online concierge system 140 may access an availability computer model of the online concierge system 140 (e.g., via the item availability module 260) trained to generate an availability score for each item in the identified set of one or more replacement items. The online concierge system 140 may apply the availability computer model (e.g., via the item availability module 260) to generate, based on information from a retailer in relation to the identified set of one or more replacement items, the availability score for each item in the identified set of one or more replacement items. The online concierge system 140 may identify the failure of the replacement computer model by identifying (e.g., via the item availability module 260) that the availability score for each item in the identified set of one or more replacement items is below a threshold score.

The online concierge system 140 may access an availability computer model of the online concierge system 140 (e.g., via the item availability module 260) trained to generate an availability score for one or more items. The online concierge system 140 may apply the availability computer model (e.g., via the item availability module 260) to determine, based on information from a retailer in relation to an item category associated with the identified set of one or more replacement items, an availability score for the item category. The online concierge system 140 may identify the failure of the replacement computer model by identifying (e.g., via the item availability module 260) that the availability score for the item category is below a threshold score.

The online concierge system 140 collects 430 (e.g., via the recipe prediction module 270), from a database of recipes of the online concierge system 140 (e.g., as available at the data store 240) and based on the name of the inferred recipe, a set of one or more recipes. The online concierge system 140 identifies 435 (e.g., via the recipe prediction module 270), from the set of one or more recipes, based on the replacement item category, a set of one or more candidate replacement items.

The online concierge system 140 may access an availability computer model of the online concierge system 140 (e.g., via the item availability module 260) trained to generate an availability score for each item in the identified set of one or more candidate replacement items. The online concierge system 140 may apply the availability computer model (e.g., via the item availability module 260) to generate, based on information from a retailer in relation to the identified set of one or more candidate replacement items, an availability score for each item in the identified set of one or more candidate replacement items. The online concierge system 140 may select (e.g., via the item availability module 260), based on the availability score for each item in the identified set of one or more candidate replacement items, the one or more replacement items from the identified set of one or more replacement items.

The online concierge system 140 may apply the replacement computer model (e.g., via the item replacement module 250) to identify, based at least in part on the one or more features of the item, the name of the recipe and the replacement item category, the one or more replacement items from the identified set of one or more candidate replacement items. The online concierge system 140 may apply the recipe prediction computer model (e.g., via the recipe prediction module 270) to infer, further based on a purchase history of the user, a confidence score for replacing a category of the item with the replacement item category. The online concierge system 140 may apply the replacement computer model (e.g., via the item replacement module 250) to identify, further based on the confidence score, the one or more replacement items.

The online concierge system 140 causes 440 (e.g., via the content presentation module 210) a device associated with the user (e.g., the user client device 100) to display a user interface with one or more replacement items selected from the set of one or more candidate replacement items for recommendation to the user to be included in the cart instead of the item. Responsive to inferring the name of the recipe and the replacement item category, the online concierge system 140 may generate (e.g., via the content presentation module 210) an inquiry message for the user including the name of the recipe and the replacement item category. The online concierge system 140 may cause (e.g., via the content presentation module 210) the device associated with the user to display the user interface further with the inquiry message prompting the user to confirm whether the inference of the recipe is correct.

The online concierge system 140 may collect (e.g., via the machine-learning training module 230) data about a conversion by the user of the one or more replacement items. The online concierge system 140 may re-train (e.g., via the machine-learning training module 230), based at least in part on the collected data, at least one of the replacement computer model or the recipe prediction computer model by updating, based at least in part on the collected data, at least one of a set of parameters of the replacement computer model or a set of parameters of the recipe prediction computer model. Alternatively or additionally, the online concierge system 140 may collect (e.g., via the machine-learning training module 230) feedback data with information about a response by the user to the inquiry message. The online concierge system 140 may re-train at least one of the replacement computer model or the recipe prediction computer model by updating (e.g., via the machine-learning training module 230), based at least in part on the collected feedback data, at least one of the set of parameters of the replacement computer model or the set of parameters of the recipe prediction computer model. The online concierge system 140 may collect (e.g., via the machine-learning training module 230) mapping data that map a set of recipes from the database of recipes to a set of items that were included in a plurality of carts by a group of users of the online concierge system 140 upon the group of users interacted with the set of recipes, the set of items included in the carts being associated with a set of ingredients in the set of recipes. The online concierge system 140 may train (e.g., via the machine-learning training module 230), based at least in part on the mapping data, at least one of the set of parameters of the replacement computer model or the set of parameters of the recipe prediction computer model.

Embodiments of the present disclosure are directed to the online concierge system 140 that suggests item replacements based on an inferred user's intent (i.e., recipe intent), but only after the more specific replacements are not available. The online concierge system 140 utilizes the recipe prediction computer model trained on a dataset of recipes to analyze items in a user's current cart to predict an inferred recipe or composite item. Upon the recipe or composite item is predicted, the online concierge system 140 utilizes the trained replacement computer model to make context-aware suggestions for replacements based on the predicted inferred recipe or composite item, while taking into account potential low-stock conditions in the entire product category. The online concierge system 140 may further provide dynamic and intent-specific prompts to a user based on the inferred recipe or composite item and possible low-stock situations. The online concierge system 140 may utilize user feedback on the prompts and suggested replacements to refine predictive accuracies of the machine-learning computer models utilized by the online concierge system 140.

The online concierge system 140 presented herein improves the user experience in the online shopping scenario, offering more accurate and relevant product replacements, and is particularly helpful in low-stock conditions. By efficiently utilizing and retraining the machine-learning computer models, dynamic customer prompts, and user feedback, the online concierge system 140 presented herein aligns suggested replacements with a user's specific shopping intent, enhancing the overall online shopping experience.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving a signal indicating that an item in a cart requested by a user of an online system is not available;
accessing a replacement computer model of the online system trained to identify a set of one or more replacement items for replacing the item;
applying the replacement computer model to score, based at least in part on one or more features of the item, each replacement item in the identified set of one or more replacement items;
responsive to identifying a failure of the replacement computer model to identify one or more suitable replacement items according to defined criteria, accessing a recipe prediction computer model of the online system trained to infer a recipe that is potentially associated with the item;
applying the recipe prediction computer model to output, based at least in part on the one or more features of the item and information about one or more ingredients in the cart, a name of the inferred recipe and a replacement item category from content of the inferred recipe;
collecting, from a database of recipes of the online system and based on the name of the inferred recipe, a set of one or more recipes;
identifying, from the set of one or more recipes, based on the replacement item category, a set of one or more candidate replacement items; and
causing a device associated with the user to display a user interface with one or more replacement items selected from the set of one or more candidate replacement items for recommendation to the user to be included in the cart instead of the item.

2. The method of claim 1, wherein identifying the failure of the replacement computer model to identify the one or more suitable replacement items according to the defined criteria comprises:
applying the replacement computer model to generate, based at least in part on the one or more features of the item, a confidence score for availability of each replacement item in the identified set of one or more replacement items; and
identifying that the confidence score for availability of each item in the identified set of one or more replacement items is below a threshold score.

3. The method of claim 1, wherein identifying the failure of the replacement computer model to identify the one or more suitable replacement items according to the defined criteria comprises:
accessing an availability computer model of the online system trained to generate an availability score for each item in the identified set of one or more replacement items;
applying the availability computer model to generate, based on information from a retailer in relation to the identified set of one or more replacement items, the availability score for each item in the identified set of one or more replacement items; and
identifying that the availability score for each item in the identified set of one or more replacement items is below a threshold score.

4. The method of claim 1, wherein identifying the failure of the replacement computer model to identify the one or more suitable replacement items according to the defined criteria comprises:
accessing an availability computer model of the online system trained to generate an availability score for one or more items;
applying the availability computer model to determine, based on information from a retailer in relation to an item category associated with the identified set of one or more replacement items, an availability score for the item category; and
identifying that the availability score for the item category is below a threshold score.

5. The method of claim 1, wherein selecting the one or more replacement items from the set of one or more candidate replacement items comprises:
accessing an availability computer model of the online system trained to generate an availability score for each item in the identified set of one or more candidate replacement items;
applying the availability computer model to generate, based on information from a retailer in relation to the identified set of one or more candidate replacement items, an availability score for each item in the identified set of one or more candidate replacement items; and
selecting, based on the availability score for each item in the identified set of one or more candidate replacement items, the one or more replacement items from the identified set of one or more replacement items.

6. The method of claim 1, wherein selecting the one or more replacement items from the set of one or more candidate replacement items comprises:
applying the replacement computer model to identify, based at least in part on the one or more features of the item, the name of the recipe and the replacement item category, the one or more replacement items from the identified set of one or more candidate replacement items.

7. The method of claim 6, wherein selecting the one or more replacement items from the set of one or more candidate replacement items further comprises:
applying the recipe prediction computer model to infer, further based on a purchase history of the user, a confidence score for replacing a category of the item with the replacement item category; and
applying the replacement computer model to identify, further based on the confidence score, the one or more replacement items.

8. The method of claim 1, wherein receiving the signal comprises:
receiving, from a device of a picker associated with the online system, during fulfillment of an order, the signal indicating that the item in the cart is not available at a store of a retailer.

9. The method of claim 1, further comprising:
collecting mapping data that map a set of recipes from the database of recipes to a set of items that were included in a plurality of carts by a group of users of the online system upon the group of users interacted with the set of recipes, the set of items included in the plurality of carts associated with a set of ingredients in the set of recipes; and
training, based at least in part on the mapping data, a set of parameters of the recipe prediction computer model.

10. The method of claim 1, further comprising:
collecting data about a conversion by the user of the one or more replacement items; and
re-training at least one of the replacement computer model or the recipe prediction computer model by updating, based at least in part on the collected data, at least one of a set of parameters of the replacement computer model or a set of parameters of the recipe prediction computer model.

11. The method of claim 1, wherein displaying the user interface further comprises:
responsive to inferring the name of the recipe and the replacement item category, generating an inquiry message for the user including the name of the recipe and the replacement item category; and
causing the device associated with the user to display the user interface further with the inquiry message prompting the user to confirm whether the inference of the recipe is correct.

12. The method of claim 11, further comprising:
collecting feedback data with information about a response by the user to the inquiry message; and
re-training at least one of the replacement computer model or the recipe prediction computer model by updating, based at least in part on the collected feedback data, at least one of a set of parameters of the replacement computer model or a set of parameters of the recipe prediction computer model.

13. A computer program product comprising a non-transitory computer readable storage medium having instructions encoded thereon that, when executed by a processor, cause the processor to perform steps comprising:
receiving a signal indicating that an item in a cart requested by a user of an online system is not available;
accessing a replacement computer model of the online system trained to identify a set of one or more replacement items for replacing the item;
applying the replacement computer model to score, based at least in part on one or more features of the item, each replacement item in the identified set of one or more replacement items;
responsive to identifying a failure of the replacement computer model to identify one or more suitable replacement items according to defined criteria, accessing a recipe prediction computer model of the online system trained to infer a recipe that is potentially associated with the item;
applying the recipe prediction computer model to output, based at least in part on the one or more features of the item and information about one or more ingredients in the cart, a name of the inferred recipe and a replacement item category from content of the inferred recipe;
collecting, from a database of recipes of the online system and based on the name of the inferred recipe, a set of one or more recipes;
identifying, from the set of one or more recipes, based on the replacement item category, a set of one or more candidate replacement items; and
causing a device associated with the user to display a user interface with one or more replacement items selected from the set of one or more candidate replacement items for recommendation to the user to be included in the cart instead of the item.

14. The computer program product of claim 13, wherein the instructions further cause the processor to perform steps comprising:
applying the replacement computer model to generate, based at least in part on the one or more features of the item, a confidence score for availability of each replacement item in the identified set of one or more replacement items; and
identifying that the confidence score for availability of each item in the identified set of one or more replacement items is below a threshold score.

15. The computer program product of claim 13, wherein the instructions further cause the processor to perform steps comprising:
accessing an availability computer model of the online system trained to generate an availability score for each item in the identified set of one or more replacement items;
applying the availability computer model to generate, based on information from a retailer in relation to the identified set of one or more replacement items, the availability score for each item in the identified set of one or more replacement items; and
identifying that the availability score for each item in the identified set of one or more replacement items is below a threshold score.

16. The computer program product of claim 13, wherein the instructions further cause the processor to perform steps comprising:
accessing an availability computer model of the online system trained to generate an availability score for each item in the identified set of one or more candidate replacement items;
applying the availability computer model to generate, based on information from a retailer in relation to the identified set of one or more candidate replacement items, an availability score for each item in the identified set of one or more candidate replacement items; and
selecting, based on the availability score for each item in the identified set of one or more candidate replacement items, the one or more replacement items from the identified set of one or more replacement items.

17. The computer program product of claim 13, wherein the instructions further cause the processor to perform steps comprising:
collecting mapping data that map a set of recipes from the database of recipes to a set of items that were included in a plurality of carts by a group of users of the online system upon the group of users interacted with the set of recipes, the set of items included in the plurality of carts associated with a set of ingredients in the set of recipes; and
training, based at least in part on the mapping data, a set of parameters of the recipe prediction computer model.

18. The computer program product of claim 13, wherein the instructions further cause the processor to perform steps comprising:
responsive to inferring the name of the recipe and the replacement item category, generating an inquiry message for the user including the name of the recipe and the replacement item category; and
causing the device associated with the user to display the user interface further with the inquiry message prompting the user to confirm whether the inference of the recipe is correct.

19. The computer program product of claim 18, wherein the instructions further cause the processor to perform steps comprising:
collecting feedback data with information about a response by the user to the inquiry message; and
re-training at least one of the replacement computer model or the recipe prediction computer model by updating, based at least in part on the collected feedback data, at least one of a set of parameters of the replacement computer model or a set of parameters of the recipe prediction computer model.

20. A computer system comprising:
a processor; and
a non-transitory computer-readable storage medium having instructions that, when executed by the processor, cause the computer system to perform steps comprising:
receiving a signal indicating that an item in a cart requested by a user of an online system is not available;
accessing a replacement computer model of the online system trained to identify a set of one or more replacement items for replacing the item;
applying the replacement computer model to score, based at least in part on one or more features of the item, each replacement item in the identified set of one or more replacement items;
responsive to identifying a failure of the replacement computer model to identify one or more suitable replacement items according to defined criteria, accessing a recipe prediction computer model of the online system trained to infer a recipe that is potentially associated with the item;
applying the recipe prediction computer model to output, based at least in part on the one or more features of the item and information about one or more ingredients in the cart, a name of the inferred recipe and a replacement item category from content of the inferred recipe;
collecting, from a database of recipes of the online system and based on the name of the inferred recipe, a set of one or more recipes;
identifying, from the set of one or more recipes, based on the replacement item category, a set of one or more candidate replacement items; and
causing a device associated with the user to display a user interface with one or more replacement items selected from the set of one or more candidate replacement items for recommendation to the user to be included in the cart instead of the item.
